(19) United States
(12) Patent Application Publication
(10) Pub. No.: US 2022/0337279 A1
(43) Pub. Date: Oct. 20, 2022

(54) MOVABLE CARD BAG, MAGNETIC SUCTION VEHICLE AND MOBILE PHONE BRACKET

(71) Applicant: GUANGDONG QIANDU TECHNOLOGY CO.,LTD., Dongguan (CN)

(72) Inventor: Zhiqiang Lin, Dongguan (CN)

(73) Assignee: GUANGDONG QIANDU TECHNOLOGY CO.,LTD., Dongguan (CN)

(21) Appl. No.: 17/513,329

(22) Filed: Oct. 28, 2021

(30) Foreign Application Priority Data
Apr. 15, 2021 (CN) 202120779554.1

(51) Int. Cl. H04B 1/3877; H04M 1/04

(52) U.S. Cl. CPC H04B 1/3877; H04M 1/04; H04M 2201/08

(57) ABSTRACT

This invention relates to mobile phone stand technology, specially for a portable magnetic suction card bag, car and mobile phone stand, including the first card bags model and the second card bag model, the size of the stand for described first model and the second model is the same, also both make with leather material. The first card bags model and the second card bag model at the bottom and sides are connected via car stitches, at the top of the form open end, by setting the card bag to insert the card from the open end card bag, used to put CARDS or business CARDS, etc., through the card with an elliptic hole for auxiliary take card, And through the degaussing sheet, to prevent the card from being degaussed, through the setting of the bracket plate, not only can easily hold the phone, eliminate the risk of slipping, but also to support the phone stand, simple structure, convenient to use.

### CROSS-REFERENCE TO RELATED APPLICATIONS

The instant application claims priority to Chinese Patent Application 202120779554.1, filed on Apr. 15, 2021, which is incorporated herein by reference.

### TECHNICAL FIELD

The invention relates to the technical field of mobile phone bracket, in particular to a mobile card bag, magnetic suction vehicle and mobile phone bracket.

### TECHNICAL BACKGROUND

At present, with the development of the society, the rapid growth of smartphone ownership, the use of smart phones are not just a telephone communication tool, it can also realize online trading, shopping, traffic navigation and positioning, video, audio, and other functions, has the characteristics of diversified, multiple functional, meet the needs of users in different situations.

Existing mobile scaffold structure is relatively simple, use phone or handheld with supportive and drop off effect is poorer, and when people go out in the card or business card is not convenient to carry and easy to forget, lacks to the card bag and phone support and also with the combination of magnetic suction vehicle mounts directly on the convenience of mobile navigation devices, Therefore, a movable card bag, magnetic suction vehicle and mobile phone bracket are needed to improve the above problems.

### The Invention Content

The purpose of the invention is to provide a movable card bag, magnetic suction vehicle and mobile phone support to solve the problems raised in the background technology.

To achieve the above purposes, the invention provides the following technical scheme:

A portable magnetic suction card bag, car and mobile phone support, including card bag, card bag, including the first card bags plate and the second card bag, described the first card the size of the plate and the second card bag bag is the same. as described in the first card bags on one side of the plate away from the second card bag, equipped with supporting plate, described in the supporting plate and the length of the card bag, same card bag and the supporting plate are described using leather material.

As the preferred scheme of the invention, the bottom and both sides of the first card bag plate and the second card bag plate are sutured and connected by car stitching, and the top of the first card bag plate and the second card bag plate form an open end, and both ends of the first card bag plate and the second card bag plate are bonded with a degaussing sheet.

As the preferred scheme of the invention, the middle of the bracket plate is provided with a vertical first notch, and the bracket plate forms a fixed segment and a folding segment through the first notch. The folding segment is trapezoidal structure, and the longer side of the folding segment is close to the fixed segment.

As the preferred scheme of the invention, the side of the fixed segment away from the folding segment and the top and bottom are sutured and connected with the card bag by car stitching.

As the preferred scheme of the invention, a second notch is arranged in the middle of the first notch along the length direction of the support plate, the second notch is a rectangular structure, and the top and bottom of the second notch are provided with an incision through the support plate, and the internal part of the second notch forms a support plate through the incision.

As the preferred scheme of the invention, the supporting plate is provided with a third concave vertically arranged near the folding segment, and the supporting plate forms a supporting segment and a bonding segment through the third concave. The length of the supporting segment is greater than the length of the bonding segment, and magnets are provided inside the supporting segment and the bonding segment.

As the preferred scheme of the invention, the first card bag plate is provided with a through hole near the folding section.

As the preferred scheme of the invention, the side of the second card bag plate far from the first card bag plate is pasted with 3M gum.

Compared with the prior art, the beneficial effects of the invention are:

In this invention, by setting the card bag to insert the card from the open end card bag, used to put CARDS or business CARDS, etc., and through the degaussing, prevent card degaussing, by setting the supporting plate, can after folding, the hand through the supporting plate, the index and middle fingers holding it folding section, easily held, put an end to the risk of falling, Can also be fit and folding of the joint cross support plate and the fold formed between tank, able to fold period of fixed, mobile phones to be placed in the desktop, by folding section for phone support, and mobile phone while reclining placed or stand to place can play a good supporting effect, the device is convenient to store card, extend the functionality. It can also support the mobile phone and suction directly with the magnetic suction vehicle support to facilitate the use of mobile navigation, simple structure, easy to use.

### THE APPENDED DRAWINGS SHOW

PIC1 is a schematic diagram of the overall structure of the invention.

PIC. 2 is a schematic diagram of the card bag structure of the invention.

PIC. 3 is a schematic diagram of the bracket plate structure of the invention.

PIC. 4 is schematic diagram 1 of the bracket plate expansion of the invention;

PIC. 5 is schematic diagram 2 of the bracket plate expansion of the invention;

PIC. 6 is a schematic diagram of the standing and placing structure of the bracket plate after it is expanded.

PIC. 7 is a schematic diagram of laying down structure of the bracket plate after expansion of the invention;

PIC. 8 is a schematic diagram of the card insertion bag structure of the invention.

In the picture: 1. Card bag; 101, the first card bag board; Through hole; 102, the second card bag board; 2. Support plate; 201, the first dent; 202. Fixed section; 203. Folding section; 204. Second indentation; 205. Incision; 206. Support plate; 2061. Third indentation; Support section; 2063. Bonding section; Magnet.

### SPECIFIC IMPLEMENTATION MODE

Below will be combined with the present invention implementation example of the appended drawings, this invention implementation case clearly and completely describe the technical scheme of obviously, described the implementation of the cases is only part of the present invention, rather than the implementation of all cases, based on the example in the invention, the field common technical personnel under the premise that did not make a creative labor for all other cases. All belong to the scope of protection of the invention.

In order to facilitate the understanding, of the invention, a more comprehensive description of the invention will be given with reference to the attached drawings. Several embodiments of the invention are given in the attached drawings. However, the invention can be implemented in many different forms and is not limited to the embodiments described herein. Rather, the purpose of providing these embodiments is to make the disclosure of the invention more thorough.

It should be noted that when a component is said to be “anchored” to another component, it may be directly attached to another component or it may exist in the middle component. When a component is considered to be “connected” to another component, it may be directly connected to another component or may coexist with a centered component. The terms “vertical,” “horizontal,” “left,” “right,” and similar expressions are used for illustrative purposes only.

Unless otherwise defined, all technical and scientific terms used herein have the same meaning as those normally understood by technicians in the technical field belonging to the invention. The terms used herein in the specification of the invention are intended only to describe specific embodiments and are not intended to limit the invention. The term “and/or” as used herein includes any and all combinations of one or more related listed items.

Please refer to Pictures 1-8. The invention provides a technical solution:

A movable card bag, magnetic suction vehicle and mobile phone bracket, including card bag 1, card bag 1 comprises the first card bag board 101 and the second card bag board 102, the first card bag board 101 and the second card bag board 102 of the same size, the first card bag board 101 away from the second card bag board 102 is provided with a bracket board 2, bracket board 2 and card bag 1 the same length, Bag 1 and bracket 2 are made of leather material.

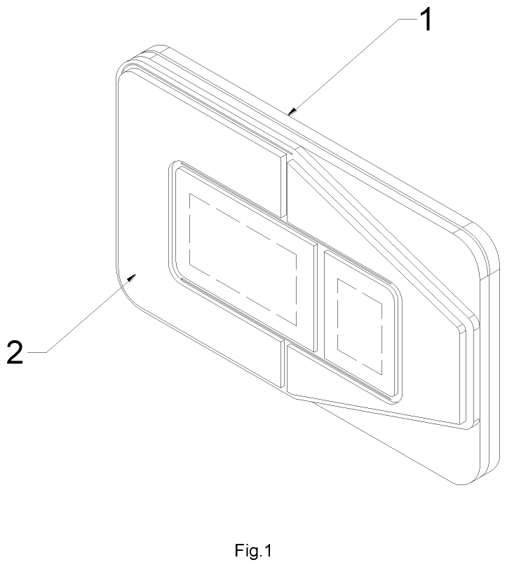

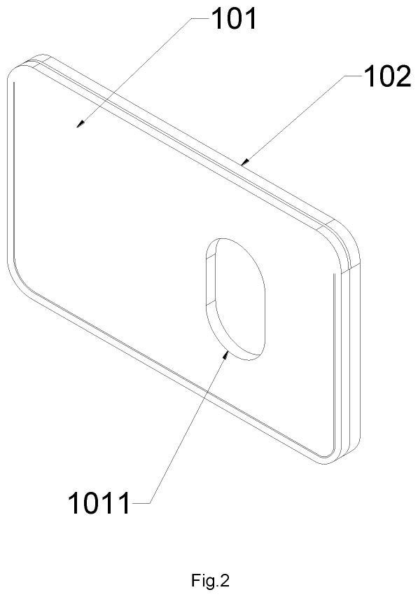

For example, please refer to FIGS. 1 and 2. The bottom and both sides of the first card bag board 101 and the second card bag board 102 are sutured and connected by car stitching, and the top of the first card bag board 101 and the second card bag board 102 form an open end, and both ends of the first card bag board 101 and the second card bag board 102 are bonded with degaussing pieces. Insert the card into the card bag 1 from the open end through the first card bag plate 101 and the second card bag plate 102 to store the card and prevent the card from being demagnetized through the degaussing sheet.

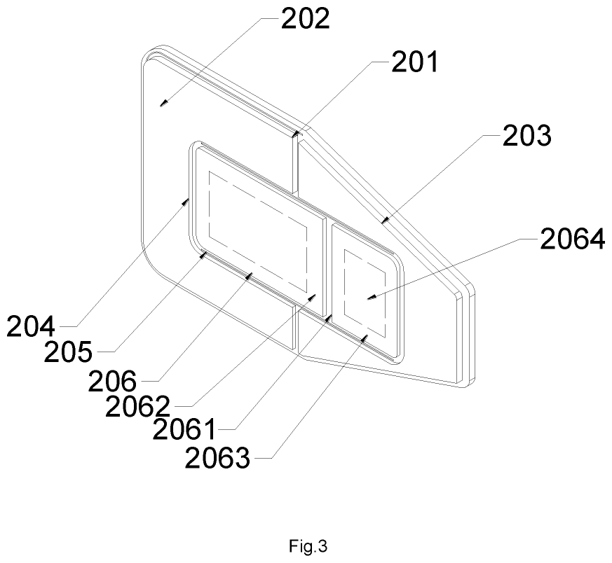

For example, please refer to FIGS. 1 and 3. The middle of bracket plate 2 is provided with the first concave 201 vertically set, and bracket plate 2 forms the fixed segment 202 and the folded segment 203 through the first concave 201. The folded segment 203 is trapezoidal structure, and the longer side of the folded segment 203 is close to the fixed segment 202. On only one side of a fixed period of folded away from the period of 202 to 203, as well as the top and bottom, are connected to the card bag 1 by car stitches, 201 in the middle of the first dent along the length direction of the supporting plate 2 sets the dent, 204, the second dent in 204 for the rectangular structure, and the second dent in 204 at the top and bottom are open 205 through supporting plate 2 incisions, Second dent 204 internal part of the support plate are formed by incision, 205, 206, by setting the supporting plate can be 2 mobile phone support, easy to use, in practical application, the folding section along the first dent 201 203 bending, make the support plate in 206 fold formed between the period of 203 and a fixed period of 202 oblique support, improve the effect of support for the mobile phone.

For example, please refer to FIGS. 1 and 3. A third concave 2061 is set vertically on the support plate 206 near the folded section 203, and the support plate 206 forms the support section 2062 and the bonding section 2063 through the third concave 2061. The length of the supporting section 2062 is greater than that of the bonding section 2063. Magnet 2064 is provided in both support section 2062 and bonding section 2063. The third indentation 2061 enables support plate 206 to form two support modes. The magnet 2064 in support section 2062 and bonding section 2063 is easy to be attached to the mobile phone bracket in the car to expand its use function.

For example, please refer to FIG. 3. The first card bag board 101 is provided with through hole 1011 near the folding section 203. Through the set through hole 1011, cards stored in card bag 1 can be easily removed and used.

For example, please refer to FIGS. 1 and 3. The side of the second card bag board 102 away from the first card bag board 101 is pasted with 3M adhesive. The 3M adhesive set is convenient to fix and bond the whole device with the mobile phone.

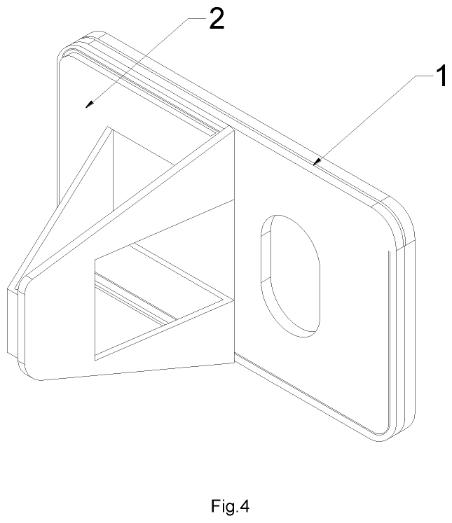

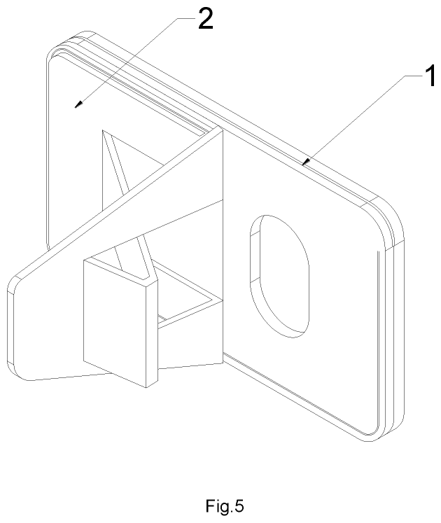

In embodiment 1, please refer to FIG. 4. In the use of the invention, the folded section 203 is first bent, and then the bonding section 2063 is glued to the folded section 203, so that the end face of the bonding, section 2063 is flush with the folded section 203, so that the triangle structure is formed between the folded section 203, the fixed section 202 and the support plate 206. By passing the hand through the support plate 2, The index finger and middle finger can hold the folding section 203, so that the mobile phone can be easily held and the risk of slipping can be eliminated.

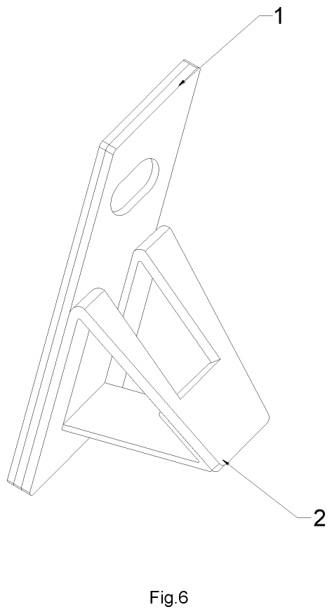

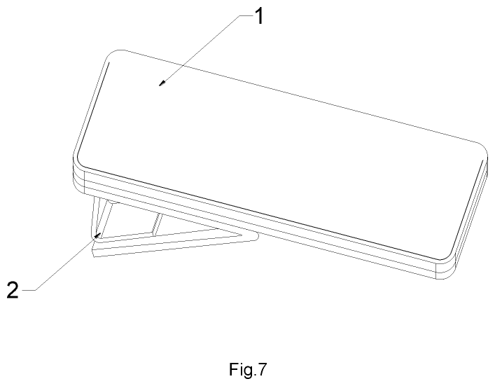

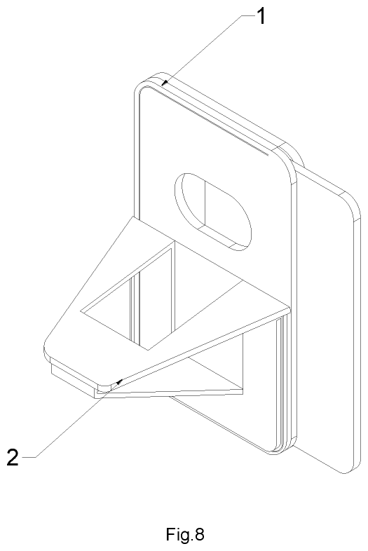

Implementation example 2, please refer to FIGS. 5, 6, and 7, the present invention is in use, the folding of the period of 203 bending, then laminating section 2063 and folding section 203 joint through the support plate groove of the folding formed between the period of 203 206, to be able to fold 203 fixed, so as to place the phone on the desktop, by folding section 203 for phone support, And the mobile phone can play a good supporting effect when lying down or standing up, easy to use.

Working principle of the invention: When used by 3 m adhesive lamination to facilitate the whole device fixed on the back of the phone, and then insert the card from the open end card bag 1, used to hold the card, and through the degaussing, prevent card degaussing, by putting a folded section 203 bending, then laminating 2063 joint on the folding section 203, the joint section of end face and folding section 203 level, 2063 Make folding section 203, fixed triangle structure formed between section 202 and the support plate 206, by putting a hand through the supporting plate 2, make the index and middle fingers holding it folding section 203, easily held, put an end to the risk of falling, or will be joint section 2063 and folding section 203 joint through the support plate groove of the folding formed between the period of 203 206, It can fix the folding section 203, so that when the mobile phone is placed on the desktop, the mobile phone can be supported by the folding section 203, which has good stability and is convenient to use.

Although embodiments of the invention have been shown and described, it is understandable to ordinary technicians in the field that these embodiments can be varied, modified, replaced, and altered in a variety of ways without deviating from the principle and spirit of the invention, and the scope of the invention is limited by the attached claims and their equivalents.

What is claimed is:

1. A movable card bag, magnetic suction vehicle and mobile phone bracket, including card bag (1), which is characterized in: Described card bag (1) includes the first card bags plate (101) and the second card bag (102), described the first card bags plate (101) and the second card bag (102) of the same size, as described in the first card bags plate (101) from the second card board (102) on one side of the bag has a supporting plate (2), described in the supporting plate (2) and card bag (1) of the same length, The card bag (1) and the bracket plate (2) are made of leather material.

2. According to the movable card bag, magnetic suction vehicle and mobile phone bracket mentioned in claim 1, its features are as follows: The bottom and both sides of the first card bag board (101) and the second card bag board (102) are connected by the car suture, and the top of the first card bag board (101) and the second card bag board (102) form an opening end, the first card bag board (101) and the second card bag board (102) contact both ends are built-in degaussing sheet.

3. According to the movable card bag, magnetic suction vehicle and mobile phone bracket mentioned in claim 1, its features are as follows: The middle of the bracket plate (2) is provided with a vertical first notch (201), and the bracket plate (2) through the first notch (201) to form a fixed segment (202) and folding segment (203), the folding segment (203) for the trapezoidal structure, and the longer side of the folding segment (203) close to the fixed segment (202).

4. According to the movable card bag, magnetic suction vehicle and mobile phone bracket mentioned in claim 3, its characteristics lie in that the side of the fixed segment (202) far from the folding segment (203) as well as the top and bottom are suitably connected with the card bag (1) through the car suture.

5. According to the movable card bag, magnetic suction vehicle and mobile phone bracket mentioned in claim 3, its features are as follows: The middle of the first dent (201) is provided with a second dent (204) along the length direction of the bracket plate (2), the second dent (204) is a rectangular structure, and the top and bottom of the second dent (204) are provided with a cut through the bracket plate (2) (205), The inner portion of the second indentation (204) forms a support plate (206) through a notch (205).

6. According to the movable card bag, magnetic suction vehicle and mobile phone bracket mentioned in claim 5, its features are as follows: The support plate (206) is provided with a vertical third notch (2061) near the folding segment (203), the support plate (206) through the third notch (2061) to form a support segment (2062) and the bonding segment (2063), the length of the support segment (2062) is greater than the length of the bonding segment (2063), The supporting section (2062) and the laminating section (2063) are provided with magnets (2064) inside.

7. According to the movable card bag, magnetic suction vehicle and mobile phone bracket mentioned in claim 1, its characteristics lie in that the first card bag plate (101) is provided with a through hole (1011) near the folding section (203).

8. According to the movable card bag, magnetic suction vehicle and mobile phone bracket mentioned in claim 1, its characteristics are: the side of said second card bag plate (102) far from the first card bag plate (101) has a built-in magnet, which can be used to suction with a magnetic phone on the back or self-selected configuration paste 3M or removable glue back.
